(19) United States
(12) Patent Application Publication
(10) Pub. No.: US 2010/0114445 A1
(43) Pub. Date: May 6, 2010

(54) DRIVING ASSISTANCE METHOD FOR MOTOR VEHICLE

(75) Inventor: Xavier Groult, Survilliers (FR)

Correspondence Address: MATTHEW R. JENKINS, ESQ., 2310 FAR HILLS BUILDING, DAYTON, OH, 45419, US

(73) Assignee: Valeo Vision, Bobigny Cedex (FR)

(21) Appl. No.: 12/610,776

(22) Filed: Nov. 2, 2009

(30) Foreign Application Priority Data
Nov. 3, 2008 (FR) 0806122

(51) Int. Cl. G06F 7/00; B60T 7/12; G01S 15/00

(52) U.S. Cl. 701/70; 367/93

(57) ABSTRACT

A driving assistance method for a motor vehicle is disclosed. It is characterised in that the method comprises the steps of detecting an obstacle located in proximity to the motor vehicle, calculating the slope of a road on which the motor vehicle is capable of travelling, determining, depending on the calculated slope of the road, a speed limit beyond which the motor vehicle will strike the obstacle, and if an obstacle is detected, automatically reducing the speed of the motor vehicle if this is greater than the speed limit.

### CROSS-REFERENCE TO RELATED APPLICATION

This application claims priority to French Application No. 0806122 filed Nov. 3, 2008, which application is incorporated herein by reference and made a part hereof.

### BACKGROUND OF THE INVENTION

I. Field of the Invention

The present invention concerns a driving assistance method for a motor vehicle, and an assistance device allowing the method to be implemented.

It is especially suitable for use in the domain of motor vehicles.

II. Description of the Related Art

In the domain of motor vehicles, there is a driving assistance method for a motor vehicle known in the prior art, which is used when a driver of the motor vehicle wants to park. It is therefore triggered at very low speeds, generally from 2 to 3 km/h. It allows the driver to avoid colliding with an obstacle during a parking maneuver. A method of this type is commonly known in English as “Park Assist”. One disadvantage of this state of the art is that it only operates in parking situations, since above these very low speeds, the assistance method for parking maneuver is not triggered and thus does not function.

The risk is that if the speed of the vehicle is above the triggering speed of the assistance method, the driver fails to realize this and nevertheless relies on the driving assistance system. In this case, even on seeing the obstacle, the driver will not brake, in the belief that the system will do it for him. However, as the assistance system is not activated, it will not assist the driver, and the obstacle will be struck at full speed. So, for a parking assistance system triggered, for example, at below 7 km/h, the system only functions when the vehicle is moving at less than 7 km/h. If the vehicle is travelling at 13 km/h, there is little chance that the driver will realize this and if an obstacle is detected, he will not brake, believing that the assistance system has been triggered, even though it is deactivated.

### SUMMARY OF THE INVENTION

The object of the present invention is a driving assistance method for a motor vehicle, which equally enables driving assistance in situations other than that of parking.

According to a first object of the invention, this aim is achieved by a driving assistance method for a motor vehicle comprising the steps of:
detecting an obstacle located in proximity to the motor vehicle;
calculating the slope of a road on which the motor vehicle is capable of travelling;
determining, depending on the calculated slope of the road, a speed limit up to which the driving assistance is effective, the motor vehicle striking the obstacle beyond this speed limit; and
if an obstacle is detected, automatically reducing the speed of the motor vehicle if this is greater than the speed limit.

Hence, even when the driving assistance function is no longer effective, in the sense that it will not prevent the collision, the assistance method according to the invention will, nevertheless, be triggered, i.e. activated, and may thus nevertheless command a braking of the vehicle. The speed of the vehicle will thus nevertheless be reduced before the impact, thus reducing the amount of damage.

The method according to the invention may be used in situations in which the speed is higher than those customarily used during a parking maneuver, either because the driver is not in the process of parking, or because he has exceeded these speeds without realizing it.

As will be seen in detail below, the fact of taking into account the slope of the road as a parameter so as then to reduce the speed of the motor vehicle, and to reduce this speed if it is higher than the speed limit, will make it possible to effect this reduction in a precise fashion and to limit the effects of an impact with an obstacle located on the road if the motor vehicle should collide with this obstacle.

It is not necessary to take into account the distance from the vehicle to the obstacle. Indeed, in the case of fixed obstacles, it is already possible to define, for a given slope and without any action by the driver on the brake or accelerator pedals, a speed limit above which, as soon as a vehicle is detected, the system is incapable of completely braking the vehicle.

According to some non-limitative embodiments, the method also presents one or more of the following characteristics.

The assistance method according to the invention functions when the speed of the motor vehicle is between 7 and 20 km/h. This interval corresponds to speeds which are low, but are still higher than the speeds habitually used to park a vehicle.

The assistance method according to the invention reduces the speed of the vehicle without allowing the vehicle to stop before the obstacle.

The assistance method according to the invention triggers maximum braking if the speed of the motor vehicle is higher than the speed limit. This allows time to be saved by not forcing the system to modulate the braking. The modulation of the braking is insignificant, since the impact is going to happen anyway. It is therefore preferable to brake as much as possible.

The steps are executed if the first preliminary conditions are met. This prevents the assistance function from being made available when it is all too clear that it will be unable to operate.

The obstacle is detected by means of ultrasonic detection sensors. The advantage of such sensors is their broad cone of detection, their low cost and their omnipresence in the automotive sector. These sensors often have a limited detection distance, most often between 2 and 3 meters. It is easier to disregard the distance from the vehicle to the obstacle; from the moment an obstacle is detected the distance is 2 to 3 meters; even by this stage, it is possible to define a speed threshold above which there will be an impact.

The system may also take into account the distance to the object detected in order to define the speed limit. This allows the definition of the speed limit to be adjusted.

The method further comprises a supplementary step of determining whether the obstacle detected is situated in the trajectory of the motor vehicle. If not, this avoids activating the driving assistance. Indeed, when the obstacle is not in the trajectory of the motor vehicle, there is very little risk of colliding with this obstacle. So it is not necessary to activate a driving assistance function.

The method further comprises a supplementary step of calculating a relative speed of the motor vehicle in relation to the obstacle detected. This makes it possible to verify whether the motor vehicle is approaching an obstacle and to trigger the driving assistance if necessary.

The automatic reduction of the speed of the motor vehicle is effected by autonomous braking. This avoids the driver of the motor vehicle himself having to brake with a brake pedal.

The automatic reduction of the speed of the motor vehicle comprises a sub-step of sending a minimum braking request to accelerate triggering of the braking. This improves the braking reaction time.

The braking is effected on two or four wheels. Braking on two wheels reduces the noise and the vibrations of the motor vehicle. Braking on four wheels enables more effective braking.

The method further comprises a supplementary step of activating a readiness indicator to indicate that a driving assistance function is available/unavailable. This indicates to a driver of the motor vehicle when the driving assistance is available.

The readiness indicator is activated depending on second preliminary conditions. This allows the driver of the motor vehicle to take responsibility for his driving.

The method further comprises a supplementary step of activating an alert function, which generates a first level alert when safety conditions are reached. This warns the driver of the motor vehicle that the automatic reduction of speed is in the process of being executed, but that there is a risk of colliding with the obstacle detected unless he brakes using his brake pedal.

The method further comprises a supplementary step of activating an alert function which generates a second level of alert when dangerous conditions are reached. This warns the driver of the motor vehicle that the automatic speed reduction is in the process of being executed, but that the motor vehicle will nevertheless collide with the obstacle detected.

According to a second object of the invention, it concerns a driving assistance device for a motor vehicle, characterised in that it comprises a control unit for:
detecting an obstacle located in proximity to the motor vehicle;
calculating the slope of a road on which the motor vehicle is capable of travelling;
determining, depending on the calculated slope of the road, a speed limit beyond which the motor vehicle will strike the obstacle; and
if an obstacle is detected, automatically reducing the speed of the motor vehicle if this is greater than the speed limit.

According to a third object of the invention, it concerns a computer program product comprising one or more sequences of instructions executable by a data processing unit, the execution of the sequences of instructions enabling the method to be implemented according to any of the preceding characteristics.

Other characteristics and advantages of the present invention will be better understood with the aid of the description and of the non-limitative drawings.

### BRIEF DESCRIPTION OF THE ACCOMPANYING DRAWINGS

FIG. 1 represents a flow chart of a non-limitative embodiment of the assistance method according to the invention;

FIG. 2 represents a first diagram of a speed of a motor vehicle depending on a slope on a road on which the motor vehicle travels, the slope being used in the method from FIG. 1;

FIG. 3 represents a second diagram of a speed of a motor vehicle depending on a slope of a road on which the motor vehicle is travelling, the slope being used in the method from FIG. 1;

FIG. 4 represents four different states of a motor vehicle facing an obstacle depending on its speed, this speed being reduced according to the assistance method from FIG. 1; and

FIG. 5 illustrates a non limitative embodiment of a device for implementing the method from FIG. 1.

### DETAILED DESCRIPTION OF THE PREFERRED EMBODIMENTS

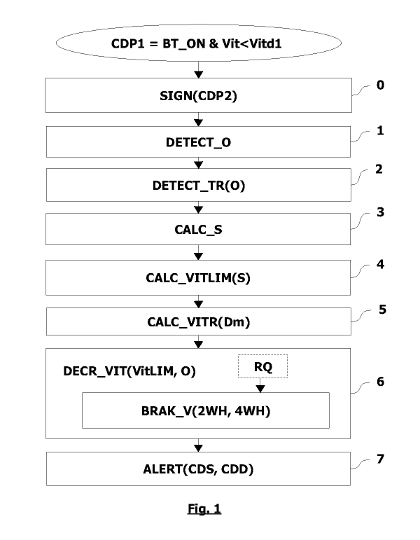

The driving assistance method for a motor vehicle, according to the invention, is described in one non-limitative embodiment in FIG. 1.

By motor vehicle, one means any vehicle containing an engine.

The assistance method comprises the following steps as illustrated in FIG. 1:
detecting an obstacle O located in proximity to the motor vehicle V (step DETECT_O);
calculating the slope S of a road R on which the motor vehicle V is capable of travelling (step CALC_S);
determining, depending on the calculated slope S of the road R, a speed limit VitLIM beyond which the motor vehicle V strikes the obstacle O (step CALC_VITLIM(S)); and
if an obstacle O is detected, automatically reducing the speed Vit of the motor vehicle V if this is greater than the speed limit VitLIM (step DECR_VIT(VitLIM, O)).

In one non-limitative embodiment, the preceding steps enabling the implementation of a driving assistance function are executed if the first preliminary conditions CDP1 are met. This prevents the assistance function from being made available when it is all too clear that it will be unable to operate.

In one non-limitative embodiment, these first preliminary conditions CDP1 are:
a demand for driving assistance by a user of the motor vehicle V; and
a speed Vit motor vehicle V less than a first maximum speed Vitd1.

In one non-limitative embodiment, the first maximum speed Vitd1 is 20 km/h.

Above this value, it is believed that the driving assistance is unable to function.

In one non-limitative embodiment, the driving assistance method further comprises a supplementary step of determining whether the obstacle O detected lies in the trajectory (TR) of the motor vehicle V (step DETECT_TR(O) illustrated in FIG. 1).

In one non-limitative embodiment, the driving assistance method further comprises a supplementary step of calculating a relative speed VitR of the motor vehicle V in relation to the obstacle detected O (step CALC_VITR(Dm) illustrated in FIG. 1).

In one non-limitative embodiment, the method further comprises a supplementary step of activating a readiness indicator SIGN to signal that a driving assistance function is available/unavailable (step SIGN(CDP2) illustrated in FIG. 1).

For the rest of the description, in the non-limitative embodiment described, the method comprises the above supplementary steps.

The steps of the method are described in detail below.

In an initial step 0), the readiness indicator SIGN is activated to signal that a driving assistance function is available/unavailable.

In one non-limitative embodiment, the readiness indicator SIGN is activated depending on second preliminary conditions CDP2.

Thus, the readiness indicator SIGN is activated to signal to the driver of the motor vehicle V that the driving assistance is:
unavailable when the second preliminary conditions CDP2 are not met; and
available when the second preliminary conditions CDP2 are met.

In one non-limitative embodiment, the second preliminary conditions CDP2 are:
a demand for driving assistance by a user of the motor vehicle V; and
a speed Vit vehicle less than a second maximum speed Vitd2.

In the non-limitative examples, the second maximum speed Vitd2 is 6 km/h.

Thus, the fact of having second preliminary conditions CDP2 more restrictive than the first preliminary conditions CDP1, notably, the fact of choosing a second maximum speed Vitd2 lower than the first maximum speed Vitd1, means that one is signalling to the driver that the driving assistance function is unavailable even though it is available. This allows the driver of the motor vehicle V to take responsibility for his driving beyond the second maximum speed Vitd2. In this case, the driver will not rely on the assistance function, although in actual fact it can function up to the first maximum speed Vitd1.

Obviously, in another embodiment, the readiness indicator SIGN can be activated depending on the first preliminary conditions CDP1 seen previously.

In one non-limitative embodiment, these second preliminary conditions CDP2 further comprise:
a slope S of the road<Sd, where Sd is a maximum slope, in reverse gear on a descending slope; and
a slope S of the road>Sd, in forward gear on a descending slope.

It will be noted that it has been assumed that:
the slope of the road is positive if the motor vehicle V is descending a slope in reverse gear (the front of the vehicle pointing towards the top of the slope); and
the slope of the road is negative if the motor vehicle V is descending a slope in forward gear (the front of the vehicle pointing towards the bottom of the slope).

Thus, a limit is applied in descent (whether the vehicle is in forward or reverse gear).

In one non-limitative example, the maximum slope Sd is 40%.

Above this value, it is believed that the driving assistance is unable to function. It will be noted that in this embodiment, this initial step 0) is executed after the calculation of the slope S (described further on in the description).

In a first step 1), an obstacle O is detected which lies in proximity to the motor vehicle V.

In one non-limitative example, this proximity to the motor vehicle V is the area ahead of the motor vehicle V.

In one non-limitative embodiment, the obstacle O is detected by means of ultrasonic sensors CAPTU. It will be noted that these sensors usually have a range of approximately 2 meters, unlike detection sensors such as lidars or radars, which have a much greater range.

Since methods using ultrasonic detection sensors CAPTU are familiar to the person skilled in the art, they are not described here.

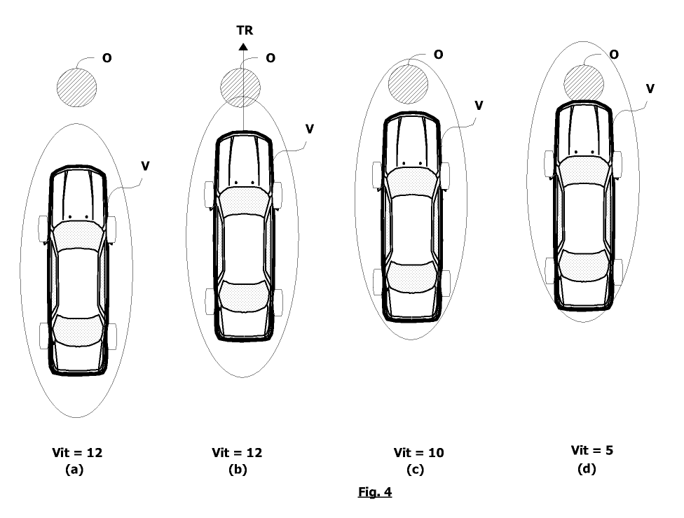

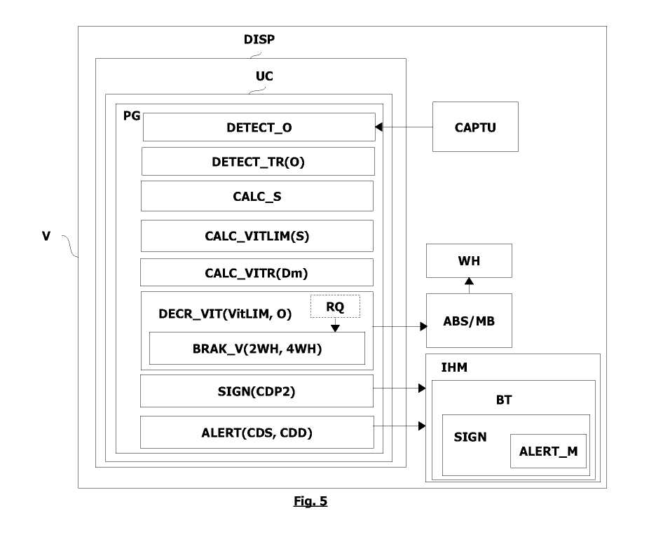

So, in the non-limitative example from FIG. 4, an obstacle O is detected in the area in front of the motor vehicle V as illustrated in FIG. 4, in situation (b), the vehicle speed Vit being 12 km/h.

If an obstacle O is detected, the following steps are taken, otherwise one returns to the initial step 0).

It will be noted that this first step of detection can be carried out in parallel with the third and fourth steps of calculating the slope and calculating the speed limit VitLIM described further on.

In a second step 2), it is determined whether the obstacle detected O lies in the trajectory TR of the motor vehicle V.

If it does lie in the trajectory TR of the motor vehicle V, the following steps are taken, otherwise one returns to the initial step 0).

So, in the non-limitative example from FIG. 4, it has been determined that the obstacle O does in fact lie in the trajectory TR of the motor vehicle V, as illustrated in FIG. 4, in situation (b).

As methods for determining an obstacle O in the trajectory of a motor vehicle V are familiar to the person skilled in the art, they are not described here.

In a third step 3), the slope S of a road R on which the motor vehicle V is travelling is calculated.

In one non-limitative embodiment, the slope S of the road R is calculated from the difference between:
a signal issued by an accelerometer
a deceleration calculated via a wheel sensor.

So, considering low vehicle speeds Vit (aerodynamic forces are disregarded) and a rolling force which is disregarded, the force Fp due to the slope S may be approximated as follows:

Fp=0.01.m.g. sin(S)

where m is the mass of the motor vehicle V and g the constant of gravity.

Fp=Fi−Ff,

where Ff is the force due to the braking of the motor vehicle V, and Fi the force due to the inertia of the motor vehicle V.

Moreover, Fi=m.Vdl, where Vdl is the measurement of the accelerometer.

In the acceleration phase:

Fp=Fi−Fm,

where Fm is the force due to engine torque.

It will be noted that the force of inertia Fi is measured by the accelerometer situated in the motor vehicle V and which is longitudinal in one non-limitative example.

The forces Fm or Ff generate an acceleration or deceleration of the wheel, measured by variations in speed of the wheel.

Moreover, Ff (or Fm)=Vdcr (in rd/s²).J/r

where J is the inertia of the wheel;

r the radius of the wheel; and

Vdcr the measurement of the wheel sensor.

This produces the following calculation of the slope S:

S=10.k1.Vdl−Vdcr.k2.10.J/(m. r)

where the coefficients k1 and k2 are close to 1 and determined empirically.

In one non-limitative example, to determine the coefficient k1, one stops on a slope of 15%. At this moment, the value of Vdcr is equal to zero, and the value of Vdl is measured. The coefficient k1 is adjusted to obtain a slope S equal to 15%.

In one non-limitative example, in order to determine the coefficient k2, one enters into a braking situation on a zero slope. At this moment, the values of Vdl and Vdcr are measured. The coefficient k2 is adjusted to obtain a zero slope S.

Obviously, other ways to calculate the slope may be taken into account.

Moreover, in one non-limitative embodiment, if the following conditions on the slope S are met, then the fourth step is carried out, otherwise one returns to the initial step 0):
a slope S of the road<Sd, where Sd is a maximum slope, in reverse gear on a descending slope; and
a slope S of the road>Sd, in forward gear on a descending slope.

It will be noted that it has been assumed that:
the slope of the road is positive if the motor vehicle V is descending a slope in reverse gear (the front of the vehicle pointing towards the top of the slope); and
the slope of the road is negative if the motor vehicle V is descending a slope in forward gear (the front of the vehicle pointing towards the bottom of the slope).

Thus, a limit is applied in descent (whether the vehicle is in forward or reverse gear).

In one non-limitative example, the maximum slope Sd is 40%.

Above this value, it is believed that the driving assistance is unable to function.

In a fourth step 4), depending on the slope S of the road R calculated, a speed limit VitLIM is determined, beyond which the motor vehicle V strikes the obstacle O.

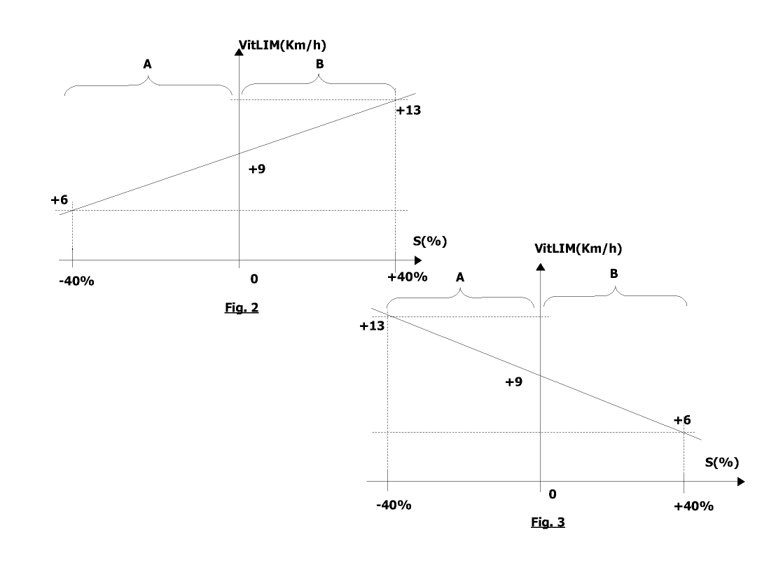

FIG. 2 illustrates a speed limit VitLIM in km/h (as ordinate) depending on the slope S in percent (as abscissa) when the motor vehicle V advances on the road R on which it is travelling.

It can be seen that:
when the slope S is 40%, the speed limit VitLIM is equal to 13 km/h (part B of the diagram). In our case, the road R is ascending and the motor vehicle V is naturally braked by the slope S.
when the slope S is −40%, the speed limit VitLIM is equal to 6 km/h (part A of the diagram). In our case, the road R is descending and the motor vehicle V is impelled naturally by the slope S.

FIG. 3 illustrates a speed limit VitLIM in km/h (as ordinate) depending on the slope S in degrees (as abscissa) when the motor vehicle V reverses on the road R on which it is travelling.

It can be seen that:
when the slope S is −40%, the speed limit VitLIM is equal to 13 km/h (part A of the diagram). In our case, the road R is descending and the motor vehicle V is naturally braked by the slope S.
when the slope S is +40%, the speed limit VitLIM is equal to 6 km/h (part B of the diagram). In our case, the road R is ascending and the motor vehicle V is naturally impelled by the slope S.

So, depending on these two diagrams, one can determine the speed limit VitLIM above which one strikes the obstacle O.

It will be noted that these speed values are determined empirically. For example, these values are determined by adopting a position on slopes for which the slope value is known and activating the driving assistance function. Thus the speed up to which the function remains effective is determined. Obviously, these values depend on which type of motor vehicle is used.

It will also be noted that the value of 6 km/h is taken in a non-limitative example where there is, moreover, a different system of automatic braking which is active, such as the engine brake. Otherwise, one may take a speed of 2 or 3 km/h in a non-limitative example.

In a fifth step 5), the relative speed VitR of the motor vehicle V in relation to the obstacle O detected is determined.

This makes it possible to determine whether or not the motor vehicle is getting closer to the obstacle detected O.

In one non-limitative embodiment, the relative speed VitR is calculated by observing the distance Dm to the obstacle O from the motor vehicle V. When this distance Dm diminishes, the vehicle is getting closer to the obstacle O, the relative speed VitR becoming negative. Otherwise, either it is zero (the distance Dm is constant), or it is positive (the distance Dm is increasing, the obstacle O is moving away).

Thus, in the non-limitative example from FIG. 4, with the aid of the relative speed VitR, it is confirmed that an obstacle O is in fact located in the area ahead of the motor vehicle V and that the vehicle has come close to it, as illustrated in FIG. 4, in situation (c).

Thus, in one non-limitative embodiment, if the relative speed VitR is less than a first speed threshold S1, then the sixth step is taken, otherwise one returns to the initial step 0.

In a first non-limitative variant, the first speed threshold S1 is equal to zero.

In a second non-limitative variant, the first speed threshold S1 is less than zero, for example equal to −0.5. This second variant will make it possible to take into account a sub-step of sending a minimum braking request, as described below.

In a sixth step 6), if an obstacle O is detected, the speed Vit of the motor vehicle V is automatically reduced if it is above the speed limit VitLIM.

In one non-limitative embodiment, the automatic reduction of the speed of the motor vehicle V is effected by autonomous braking. Autonomous braking avoids a driver of the motor vehicle V himself having to brake, using a brake pedal.

In some non-limitative embodiments, the braking can be hydraulic, electro-hydraulic or even electric.

In one non-limitative variant, the automatic reduction of the speed of the motor vehicle V comprises a preliminary sub-step of sending a minimum braking request RQ to accelerate the triggering of the braking.

The minimum braking request RQ is sent by means of a braking command sent by a control unit UC.

In the case of hydraulic or electro-hydraulic braking, the braking command is sent to the ABS pump situated in an ESC (Electronic Stability Control) modulator in order to reduce the hydraulic response time of the brakes, by filling the brake callipers with brake fluid in advance, which establishes a hydraulic pressure in the brakes, which are then “pre-loaded”. The ABS pump allows pressure to be generated/relieved in the brakes of the motor vehicle V by co-operating with a hydraulic modulator contained within the ESC modulator, which brings together the brake callipers of the brake disc.

Since the functioning of an ESC modulator is familiar to the person skilled in the art, it will not be described here.

This function of pre-pressurizing the brakes of the motor vehicle V is commonly known in English as “Brake Pre-fill”. In one non-limitative embodiment, this minimum braking request RQ allows the pressure in the brakes to be increased by one or two bars.

In the case of electric braking, the braking command is sent to an electric brake motor MB to bring together the brake callipers of the brake disc.

It will be noted that this minimum braking request RQ is effected before the automatic speed reduction is executed.

In one non-limitative embodiment, the minimum braking request RQ is sent before the automatic speed reduction is executed, if the relative speed VitR (calculated previously) is lower than a second speed threshold S2, this second speed threshold S2 being greater than the first speed threshold S1 described previously.

In one non-limitative example, this second speed threshold S2 is equal to zero and the first speed threshold S1 is negative and equal to −0.5 as described previously. If the relative speed VitR is less than zero in this case, the braking request RQ is sent, and as soon as the relative speed VitR becomes less than −0.5, the automatic speed reduction is executed.

Thus, this makes it possible:
to reduce the brake reaction time and to increase the effectiveness of the driving assistance;
to anticipate the braking which will follow to provide faster braking; and
to make braking more comfortable for a driver of the motor vehicle V because the braking will be less noticeable by the driver, as it is anticipated.

In one non-limitative embodiment, the autonomous braking is effected on two or four wheels (step BRAK_V(2WH, 4WH) illustrated in FIG. 1).

The choice of two or four wheels can be made, according to some non-limitative examples, depending on:
the speed Vit of the motor vehicle V (for example, if it is less than 5 km/h, braking on two wheels is sufficient);
if the clutch is disengaged (less braking is needed, so two wheels are sufficient) or engaged (it is necessary to use more braking to lock the brake motor, so four wheels are necessary);
brake wear (for example, if the brakes are new, the coefficient of adhesion of the road is low, so more braking is needed and four wheels are thus necessary);
the slope S of the road in the direction of travel of the motor vehicle V (two wheels are sufficient), otherwise four wheels are necessary, etc.

Obviously, the criteria described above can be combined with each other.

Obviously, during braking, one may also choose to change from one mode (choice of two wheels) to the other (choice of four wheels) or vice versa. In one non-limitative embodiment, it is possible to choose to change from braking on two wheels to braking on four wheels if one realizes that the coefficient of adhesion of the road is too low (the wheels lock).

Moreover, when two-wheel braking is selected, the choice can relate to the rear wheels or the front wheels depending on the braking potential of the wheels, i.e., depending on the normal load on the wheels. In some non-limitative examples, braking is effected on:
the rear wheels if the motor vehicle V is moving in reverse gear. In this case, the rear wheels have a greater normal load, while the front wheels are more unloaded. So there is less braking potential on an axle opposed to the direction of travel, in this case on the front wheels.
the front wheels if the motor vehicle V is moving in forward gear.

Thus, this step of automatic speed reduction of the motor vehicle V makes it possible to reduce the kinetic energy of the motor vehicle V before colliding with an obstacle O.

Thus, in the non-limitative example from FIG. 4, there has been an impact between the motor vehicle V and the obstacle O, but this impact is reduced because the speed Vit of the motor vehicle V has previously been reduced from 7 km/h and has changed from 12 km/h to 5 km/h, as illustrated in FIG. 4, in situation (d). So there is a reduction in energy of approximately 80% in this non-limitative example.

Finally, when the motor vehicle V has collided with the obstacle O, the brakes are then released. In one non-limitative embodiment, the brakes are released after a pre-determined time TP, in the order of 0.5 sec, for example. It will be noted that one is aware that the motor vehicle V has collided with the obstacle O when, for example, the distance Dm to the obstacle O is very low, for example in the order of 10 cm.

In one non-limitative embodiment, provision may also be made to actuate the electric parking brake automatically, after the autonomous braking, if the slope S of the road is greater than 2% or 3%, for example, and if the motor vehicle has stopped.

In a seventh step 7), if the automatic speed reduction is in the process of execution, an alert function ALERT is activated, which generates various levels of alert (step ALERT(CDS, CDD)) as illustrated in FIG. 1.

In a first embodiment, the alert function ALERT generates a first level of alert when safe conditions CDS are attained.

In one non-limitative variant, the safe conditions CDS are:
a vehicle speed Vit which lies within a first interval of speeds allowing the motor vehicle V to be stopped without striking an obstacle O which has been detected. In one non-limitative example, the interval lies between 3 and 7 km/h; and
the observation of internal control parameters PIC forecasting a potential danger of colliding with the obstacle O; thus, the alert function ALERT warns the driver so that he can increase the braking request by foot via the brake pedal in addition to the automatic reduction of the vehicle speed Vit.

In one non-limitative example, the internal control parameters PIC are:
a predicted distance Dp from the obstacle O evaluated depending on the acceleration/deceleration of the motor vehicle V. In one non-limitative example, Dp=Vit²/(2×deceleration), Vit² being expressed in m/s;
a distance measured Dm from obstacle O; and
the speed Vit of the motor vehicle V.

By comparing the predicted distance Dp from the obstacle O and the actual distance Dm from the obstacle O, and depending on the speed Vit of the motor vehicle V, one determines whether a danger is imminent (the fact of striking the obstacle O or not).

Thus, for example if the difference D_DIFF=Dp−Dm is negative, then one can forecast that there is no risk of striking the obstacle O.

On the contrary, if the difference D_DIFF=Dp−Dm is positive, then one can forecast that there is a risk of striking the obstacle O.

In a second embodiment, the alert function ALERT generates a second level of alert when dangerous conditions CDD are reached.

In one non-limitative variant, the dangerous conditions CDD are:
a vehicle speed Vit which lies in a second interval of speeds which do not allow the motor vehicle V to stop without colliding with an obstacle O detected. In one non-limitative example, the interval lies between 7 and 20 km/h; and
the observation of the internal control parameters, described above, forecasting a danger of colliding with the obstacle O.

In this case, the driving assistance causes the speed of the motor vehicle V to diminish, but the obstacle O will be struck before the motor vehicle V has stopped.

Obviously, these two embodiments are used in combination.

Thus, the method described enables the damage caused to an obstacle to be reduced if there is a collision, by reducing the speed of the motor vehicle before the collision takes place, and when the motor vehicle is travelling at low speed, between 1 km/h and 20 km/h. In practice, the driving assistance described above will be used, in some non-limitative examples, in the following situations:
when the motor vehicle is in a situation of moving off;
when the motor vehicle is in a situation of reverse gear;
when the motor vehicle is in traffic jams.

The method of the invention is implemented by a device DISP for driving assistance for a motor vehicle V, represented in FIG. 5.

This device DISP is integrated into the motor vehicle V.

This device DISP contains, in particular, a control unit UC for:
detecting an obstacle O located in proximity to the motor vehicle V;
calculating the slope S of a road R on which the motor vehicle V is capable of travelling;
determining, depending on the calculated slope S of the road R, a speed limit VitLIM beyond which the motor vehicle V strikes the obstacle O; and
if an obstacle O is detected, automatically reducing the speed Vit of the motor vehicle V if this is greater than the speed limit VitLIM.

In some non-limitative embodiments, the control unit UC also makes it possible:
to control the sending of a minimum braking request RQ to accelerate triggering of the braking. It does so via the ABS pump or the electric brake motor MB as previously described;
to activate the readiness indicator SIGN while driving to signal that a driving assistance function is available/unavailable; and
to activate the alert function ALERT to generate:
   a first level of alert when safe conditions CDS are attained;
   a second level of alert when dangerous conditions CDD are attained.

Moreover, the device DISP cooperates with a man-machine interface IHM comprising:
means of activation BT of the driving assistance function. In one non-limitative example, these means of activation BT are a push-button which the driver of the motor vehicle V can press to demand that the driving assistance function become available (BT_ON);
the readiness indicator SIGN previously described. In one non-limitative example, the readiness indicator SIGN is an indicator lamp with a different color assigned according to the availability or unavailability of the driving assistance function;
means of alert ALERT_M which are able, in particular, when automatic speed reduction is in the course of execution,
   to generate a first level of alert when safe conditions CDS are attained, as described previously; and
   to generate a second level of alert when dangerous conditions CDD are attained, as described previously.

These means of alert ALERT_M are, in one non-limitative example, an indicator lamp with a flashing rate assigned according to the type of level of alert emitted.

These means of alert ALERT_M can, of course, be integrated into the readiness indicator SIGN which can itself be integrated into means of activation BT, as illustrated in FIG. 5.

It will be noted that the implementation of the assistance method explained above can be effected by means of a software micro-programmed device, hard-wired logic and/or electronic hardware components.

Thus, the assistance device DISP may comprise a computer program product PG comprising one or more sequences of instructions executable by a data processing unit such as a microprocessor, or a processing unit of a microcontroller, an ASIC, a computer, or other data processing unit, the execution of the sequences of instructions enabling the implementation of the method described.

Such a computer program PG can be written to non-volatile writeable memory of the ROM type or to re-writable non-volatile memory of the type EEPROM or FLASH. The computer program PG can be written to memory in the factory or else loaded into memory or remotely downloaded into memory. The sequences of instructions may be sequences of machine instructions, or else sequences of a control language interpreted by the processing unit at the time of their execution.

In the non-limitative example from FIG. 5, the computer program PG is written into a memory of the control unit UC of the device DISP.

Obviously, the description of the method is not limited to the embodiments and examples described above.

Thus, in place of the main braking (hydraulic, electro-hydraulic or electric), in another non-limitative embodiment, it is possible to make provision for the automatic speed reduction of the motor vehicle V to take effect by a secondary autonomous braking EPB. In one non-limitative embodiment, the secondary braking is an electric parking brake commonly known in English as the “Electric Park Brake”. It will be noted that in this embodiment, the braking is effected on two wheels and is slower to react than main braking, because it is usually used when the motor vehicle V is in a parking position, in order to immobilize the motor vehicle V when parked. Moreover, it applies only for low speeds, in the order of 2 to 3 km/h.

Moreover, the driving assistance method can be combined with a classic driving assistance method used for parking situations. In this case, it is possible to make provision for the alert function ALERT to generate a third level of alert when rolling conditions CDR are attained such as, in one non-limitative example, a vehicle speed Vit which lies within an interval of speeds making it possible to stop the motor vehicle V without colliding with an obstacle O detected. In one non-limitative example, the interval lies between 1 and 7 km/h.

It is possible to make further provision to effect the automatic reduction of the speed Vit of the motor vehicle V only when the vehicle speed Vit is above a minimum speed Vitd3. This makes it possible to verify whether or not one is in a critical situation. Indeed, if the motor vehicle is moving at a very low speed Vit, for example 0.5 km/h, the situation is not critical.

Finally, in one non-limitative embodiment, provision can be made to deactivate the ultrasonic sensors CAPTU once the speed of the motor vehicle V is greater than a threshold speed, for example 40 km/h. Indeed, in this case, the ultrasonic sensors CAPTU are unusable. This allows the wear on the sensors to be reduced.

Thus, the invention presents the following particular advantages:
it enables the effects of a collision with an obstacle to be limited by reducing the kinetic energy of the motor vehicle (via the reduction of its speed) prior to impact;
it is simple to implement and can be applied to all braking systems, including electrical ones;
it makes it possible to use ultrasonic sensors, which are in common use during braking or parking, and at higher speeds than those used when parking;
it makes it possible to accelerate the reaction time of the braking by sending the minimum braking request;
it makes it possible to adopt a strategy of braking on two or four wheels;
it allows the driver of the motor vehicle to be informed whether the driving assistance function is available/unavailable; and
it makes it possible to alert the driver of the motor vehicle adequately, on the basis of the different levels of alert which are emitted, when the automatic speed reduction is in the course of execution, depending on whether safe or dangerous conditions have been attained.

While the method herein described, and the form of apparatus for carrying this method into effect, constitute preferred embodiments of this invention, it is to be understood that the invention is not limited to this precise method and form of apparatus, and that changes may be made in either without departing from the scope of the invention, which is defined in the appended claims.

What is claimed is:

1. The driving assistance method for a motor vehicle (V) comprising the steps of:
detecting an obstacle (O) located in proximity to the motor vehicle (V);
calculating a slope (S) of a road on which the motor vehicle (V) is capable of travelling;
depending on the calculated slope (S) of the road, determining a speed limit (VitLIM) up to which driving assistance is effective, the motor vehicle (V) striking said obstacle (O) beyond this speed limit; and
if an obstacle (O) is detected, automatically reducing the speed (Vit) of the motor vehicle (V) if this is greater than said speed limit (VitLIM).

2. The driving assistance method according to claim 1, according to which said driving assistance method functions when the speed (Vit) of the motor vehicle (V) lies between 7 and 20 km/h.

3. The driving assistance method according to claim 1, according to which said driving assistance method reduces the speed of the vehicle without permitting the vehicle to stop before the obstacle.

4. The driving assistance method according to claim 1, according to which the steps are executed if the first preliminary conditions (CDP1) are met.

5. The driving assistance method according to claim 1, wherein an obstacle (O) is detected by means of ultrasonic detection sensors (CAPTU).

6. The driving assistance method according to claim 1, wherein said method further comprises a supplementary step of determining whether the obstacle detected (O) is located in a trajectory (TR) of the motor vehicle (V).

7. The driving assistance method according to claim 1, wherein said method further comprises a supplementary step of calculating a relative speed (VitR) of the motor vehicle (V) to the obstacle detected (O).

8. The driving assistance method according to claim 1, wherein an the automatic reduction of the speed (Vit) of the motor vehicle (V) is effected by autonomous braking, said automatic reduction of the speed (Vit) of the motor vehicle (V) comprising a sub-step of sending a minimum braking request (RQ) to accelerate triggering of braking.

9. The driving assistance method according to claim 8, wherein said automatic reduction of the speed (Vit) of the motor vehicle (V) is effected by autonomous braking, the braking being effected on two or four wheels.

10. The driving assistance method according to claim 1, wherein said method further comprises a supplementary step of activating a readiness indicator (SIGN) to signal that a driving assistance function is available/unavailable.

11. The driving assistance method according to claim 10, wherein the readiness indicator (SIGN) is activated depending on second preliminary conditions (CDP2).

12. The driving assistance method according to claim 1, wherein said method further comprises a supplementary step of activating an alert function (ALERT) which generates a first level of alert when safe conditions (CDS) are reached.

13. The driving assistance method according to claim 1, wherein said method further comprises a supplementary step of activating an alert function (ALERT) which generates a second alert level when dangerous conditions (CDD) are reached.

14. A driving assistance device (DISP) for a motor vehicle (V), said driving assistance device (DISP) comprises:
a control unit (UC);
said control unit:
detecting an obstacle (O) located in proximity to the motor vehicle (V);
calculating the slope (S) of a road on which the motor vehicle (V) is capable of travelling;
determining, depending on the calculated slope (S) of the road, a speed limit (VitLIM) beyond which the motor vehicle (V) strikes said obstacle (O); and
if an obstacle (O) is detected, automatically reducing the speed (Vit) of the motor vehicle (V) if this is greater than said speed limit (VitLIM).

15. A computer program product (PG) comprising one or more sequences of instructions which can be executed by a data processing unit, the execution of said one or more sequences of instructions enabling the method according to claim 1 to be implemented.
